(19) United States
(12) Patent Application Publication
(10) Pub. No.: US 2018/0318833 A1
(43) Pub. Date: Nov. 8, 2018

(54) MICROFLUIDIC CHANNEL FILTER

(71) Applicant: HEWLETT-PACKARD DEVELOPMENT COMPANY, L.P., Fort Collins, CO (US)

(72) Inventors: Steven BARCELO, Palo Alto, CA (US); Ning GE, Palo Alto, CA (US); Anita ROGACS, San Diego, CA (US)

(21) Appl. No.: 15/764,305

(22) PCT Filed: Oct. 30, 2015
(86) PCT No.: PCT/US2015/058477

§ 371 Date: Mar. 28, 2018

(51) Int. Cl. B01L 3/00

(52) U.S. Cl. CPC B01L 3/502707; B01L 3/502753; B01L 3/5025; B01L 2200/027; B01L 2300/0816; B01L 2400/0415; B01L 2300/0681

(57) ABSTRACT

In an example implementation, a method of fabricating a microfluidic channel filter, includes depositing an imprintable material in a microfluidic channel, pressing an imprint stamp with a filter pattern into the imprintable material, curing the imprintable material, and removing the imprint stamp from the imprintable material.

### BACKGROUND

Lab-on-a-chip (LOC) devices enable the scaling down of laboratory functions to a miniaturized environment. LOC devices can integrate several laboratory functions on a single chip that processes very small volumes of fluid. Thus, the realization of LOC devices involves the integration of a variety of components into a very small form factor.

### BRIEF DESCRIPTION OF THE DRAWINGS

Examples will now be described with reference to the accompanying drawings, in which:

FIG. 1 shows a side view of an example substrate that has an example imprintable material deposited in an example microfluidic channel formed in the substrate;

FIG. 2 shows a side view of an example substrate with an example microfluidic channel and an imprint stamp during curing of an imprintable material;

FIG. 3 shows a side view of an example substrate with a microfluidic channel after curing of an imprintable material;

FIG. 4 shows a side view of an example of a microfluidic chip after the formation of an example microfluidic channel filter and the placement of a chip top over the microfluidic channel and filter;

FIG. 5 shows a top view of an example substrate that has an example microfluidic channel formed therein;

FIG. 6 shows a flow diagram of an example method that parallels an imprint process illustrated in FIGS. 1-4;

FIG. 7 shows a flow diagram of an alternate example method that illustrates additional details of the imprint process illustrated in FIGS. 1-4;

FIG. 8 shows a flow diagram of an alternate example method that parallels the imprint process illustrated in FIGS. 1-4.

Throughout the drawings, identical reference numbers designate similar, but not necessarily identical, elements.

### DETAILED DESCRIPTION

Lab-on-a-chip (LOC) devices are used in different life science industries for a variety of purposes such as biomedical diagnostics, drug development, DNA replication, and so on. Laboratory functions performed on LOC devices often rely on different upstream fluid sample preparations. Preparing samples can involve the mixing of fluids, the filtering of fluids, the heating of fluids, combinations thereof, and so on. Microfluidics involves the manipulation and control of such fluids within the miniaturized LOC environments through the integration and implementation of a variety of components into a very small form factor.

Many microfluidic applications involve upstream filtration of fluid samples prior to downstream analysis of the fluid. The accuracy of some substance detection mechanisms, for example, can depend on the removal of unwanted particles from a fluid sample. Efforts toward integrating microfilters into the microfluidic channels of LOC and other microfluidic devices are ongoing. One prior method of integrating a filter into a microfluidic device, for example, involves packing very small, nano/micro particles into a microfluidic channel. The size of the nano/micro particles can be selected to trap certain targeted species such as cells and molecules of a known size. Other types of microfluidic filters include, for example, membrane filters, electrokinetic filters, and fiber filters. Filter characteristics, such as the particle filtration size, can be difficult to control with such filters. In addition, such filters are often built first and then integrated into the microfluidic device. This incorporation step adds complication to the assembly process.

Accordingly, examples of a microfluidic channel filter and methods of fabricating a microfluidic channel filter are described herein. In various examples, a micro/nanoporous filter is built into a microfluidics channel to enable simplified sample preparation for downstream processing. A nanoimprinting fabrication method allows integration of the filter directly into a microchannel without complicated processing. Filter parameters such as pore size and density can be directly patterned and reliably replicated using the nanoimprint lithography fabrication method. The use of imprint lithography enables the reliable fabrication of numerous filters having consistent parameters, which assures repeatable filter performance across the filters.

A microfluidic channel filter, or a series of such filters, can be fabricated on a microfluidics chip by a nanoimprinting method comprising several simple operations. In an example implementation, one operation of such a method includes depositing an imprintable material such as an ultra-violet (UV) or thermally curable polymer, in a region or regions of a microchannel or microchannels on a microfluidics device. In another operation, an imprint stamp with a desired filter feature topology is aligned to the device, and the two pieces are pressed together. In another operation, the deposited material is cured and the stamp is removed, which leaves behind the desired filter pore structure.

In another example implementation, a microfluidic channel filter includes a substrate, and a microfluidic channel formed in the substrate. The filter also includes an imprintable polymer material deposited in the microfluidic channel and imprinted with a filter pattern.

In another example implementation, an example method of fabricating a microfluidic channel filter includes jetting a photo-curable liquid resist into a localized area of a microfluidic channel. An imprint stamp is then pressed into the liquid resist, and ultra-violet light is applied to the liquid resist until the liquid resist is cured. The method includes removing the imprint stamp from the cured liquid resist, leaving behind a filter pattern from the imprint stamp in the cured liquid resist.

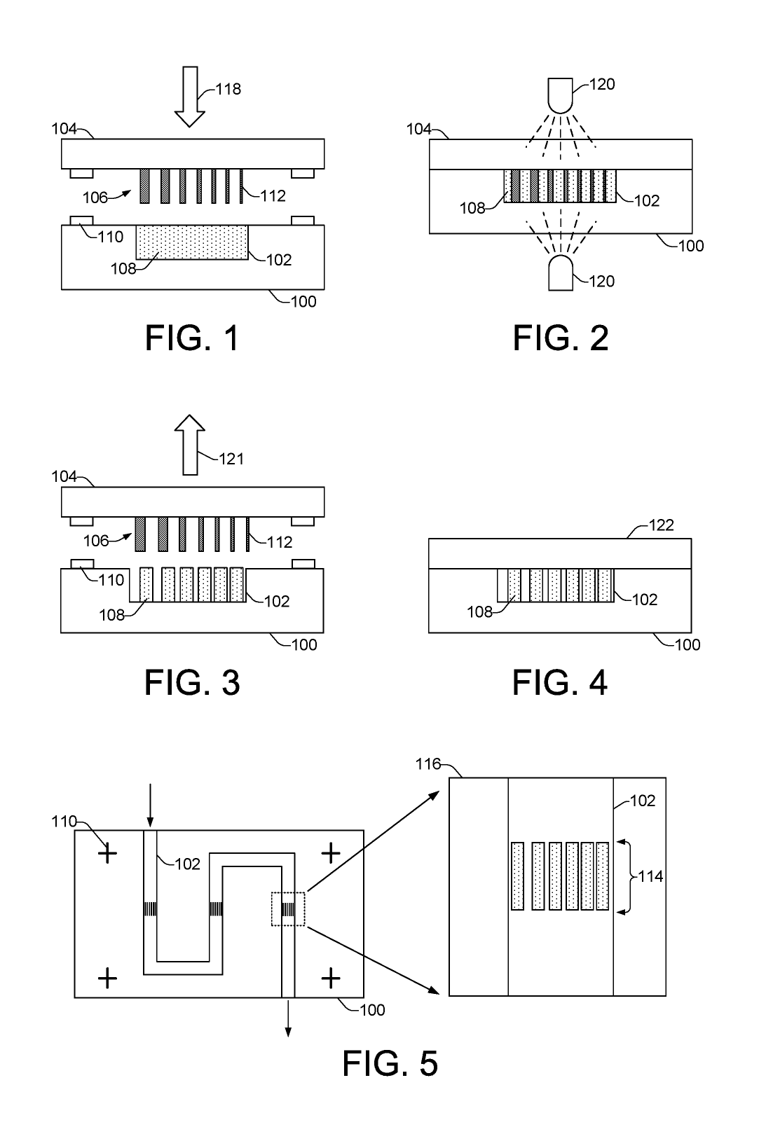

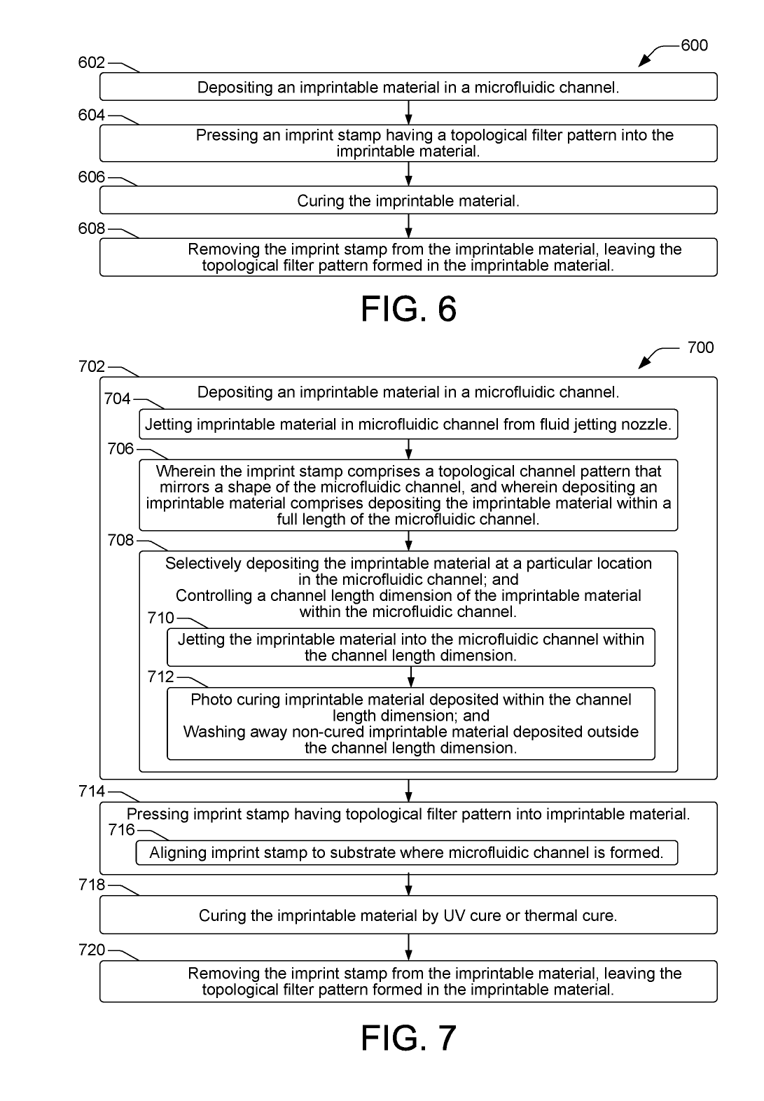

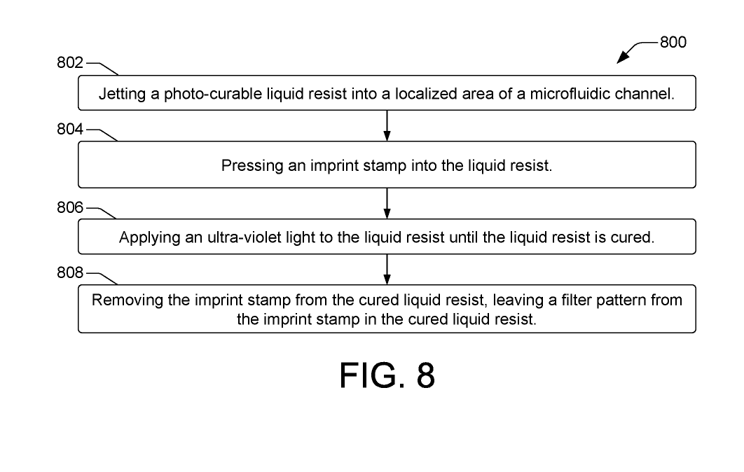

FIGS. 1-4 illustrate an example process for fabricating a microfluidic channel filter into a microfluidic channel of a microfluidic chip, such as a lab-on-a-chip (LOC), or a filter block chip, using nanoimprint lithography. FIG. 6 is a flow diagram of an example method 600 that parallels the process illustrated in FIGS. 1-4. FIG. 7 is a flow diagram of an alternate example method 700 that illustrates additional details of the process illustrated in FIGS. 1-4. FIG. 8 is a flow diagram of an alternate example method 800 that parallels the process illustrated in FIGS. 1-4.

FIG. 1 shows a side view of a substrate 100 that has a microfluidic channel 102 formed therein. The substrate 100 can comprise the substrate of a chip, such as the substrate of a lab-on-a-chip (LOC) or a filter block chip, for example. A filter block chip is a chip that provides filtering of fluid flowing through a microfluidic channel 102. The filter block chip can be inserted into the flow of fluid flowing into a lab-on-a-chip, for example, to provide upstream fluid sample preparation for laboratory functions being performed on the LOC. Also shown in FIG. 1 is an imprint stamp 104 that comprises a three-dimensional topology or profile that forms the shape of a filter pattern 106. The substrate 100 and imprint stamp 104 can be formed of various materials including silicon and fused silica (quartz), for example. One and/or the other of the substrate 100 and the imprint stamp 104 can be formed of fused silica in order to remain transparent to enable ultra-violet (UV) curing of an imprintable polymer material 108 deposited in the microfluidic channel 102. The substrate 100 and imprint stamp 104 both include alignment marks 110 to facilitate alignment with one another. The filter pattern 106 of the imprint stamp 104 is formed by finger-like protrusions 112 extending from and integrated with the imprint stamp 104.

Referring now primarily to FIG. 1 and the flow diagrams of FIGS. 6-8, a nanoimprint process/method for fabricating a microfluidic channel filter into the microfluidic channel 102 can begin with depositing an imprintable material 108 into the channel (FIG. 6, block 602; FIG. 7, block 702). The imprintable material 108 can comprise a photo or thermal curable polymer resist, and in some examples comprises a jettable liquid polymer resist. Thus, deposition of the imprintable material 108 can include jetting the imprintable material 108 into the microfluidic channel from a fluid jetting nozzle (FIG. 7, block 704; FIG. 8, block 802). An example of a suitable fluid jetting nozzle can include an inkjet printing nozzle.

In some examples, deposition of an imprintable material 108 can include depositing the imprintable material within a full length of the microfluidic channel (FIG. 7, block 706). In such examples, in addition to forming a filter pattern 106, the imprint stamp 104 can form a pattern that mirrors the shape of the microfluidic channel 102. In other examples, deposition of an imprintable material 108 can include selectively depositing the imprintable material at a particular location within the microfluidic channel, and controlling a channel length dimension 114 (FIG. 5) of the imprintable material within the microfluidic channel (FIG. 7, block 708).

FIG. 5 shows a top view of substrate 100 that has a microfluidic channel 102 formed therein. FIG. 5 also includes a blow up view 116 of a portion of the microfluidic channel 102. In FIG. 5, the channel length dimension 114 comprises a length within the channel 102 into which the imprintable material 108 can be deposited and/or constrained. That is, the deposited imprintable material 108 will not extend beyond the channel length dimension 114. The location of the imprintable material within the channel length dimension 114 can be achieved, for example, by the precise jetting of the material into the dimension 114 (FIG. 7, block 710), or by photo curing imprintable material that has been deposited within the channel length dimension, and then washing away (e.g., with a chemical bath) non-cured imprintable material that has been imprecisely deposited outside of the channel length dimension (FIG. 7, block 712).

After the imprintable material 108 is deposited in the microfluidic channel 102, the nanoimprint process/method for fabricating a microfluidic channel filter into the microfluidic channel 102 can continue with pressing the imprint stamp 104 having a topological filter pattern 106 into the imprintable material 108 (FIG. 6, block 604; FIG. 7, block 714; FIG. 8, block 804). This is indicated in FIG. 1, by the direction arrow 118. Before pressing the imprint stamp 104 into the imprintable material 108, the alignment marks 110 on the imprint stamp 104 and substrate 100 can be used to align the stamp 104 and substrate 100 (FIG. 7, block 716) so that the filter pattern 106 is pressed into the imprintable material 108 at precisely the same location each time.

Referring now also to FIG. 2, while pressing the imprint stamp 104 into the imprintable material 108, the imprintable material is cured (FIG. 6, block 606; FIG. 7, block 718; FIG. 8, block 806). The cure can be a thermal cure or a UV cure (FIG. 7, block 718). Thus, heat or UV light 120 can be applied to the imprintable material 108 until it is cured. As noted above with reference to FIG. 1, one or the other of the substrate 100 and the imprint stamp 104 can be formed of a transparent material such as fused silica (quartz) in order to enable ultra-violet (UV) curing of the imprintable polymer material 108 deposited in the microfluidic channel 102. Thus, UV light 120 can come through either the substrate 100 or the imprint stamp 104 to cure the imprintable polymer material 108. In some examples, the UV light source 120 can comprise a heat source in the event the imprintable polymer material 108 is thermally curable instead of UC curable.

Referring now also to FIG. 3, after the cure is complete, the imprint stamp 104 is removed from the imprintable material 108 as indicated by direction arrow 121. Removal of the imprint stamp leaves the topological filter pattern 106 of the imprint stamp 104 formed into the imprintable material 108 as the microfluidic channel filter (FIG. 6, block 608; FIG. 7, block 720; FIG. 8, block 808). Referring to FIG. 4, a chip top 122 is put on the substrate 100 over the microfluidic channel 102.

The example microfluidic channel filter disclosed here is easy to fabricate and incorporate in a microchannel, simplifying integration with a lab-on-a-chip. The use of nanoimprint lithography as discussed herein enables the repeatable replication of a microfluidic channel filter with a given pore design and resolution. The potential resolution using this method is below 10 nm (nanometer).

What is claimed is:

1. A method of fabricating a microfluidic channel filter, comprising:
depositing an imprintable material in a microfluidic channel;
pressing an imprint stamp having a topological filter pattern into the imprintable material;
curing the imprintable material; and
removing the imprint stamp from the imprintable material, leaving the topological filter pattern formed in the imprintable material.

2. A method as in claim 1, wherein curing comprises exposing the imprintable material to heat.

3. A method as in claim 1, wherein curing comprises exposing the imprintable material to ultra-violet light.

4. A method as in claim 1, wherein pressing the imprint stamp into the imprintable material comprises aligning the imprint stamp to a substrate on which the microfluidic channel is formed.

5. A method as in claim 1, wherein depositing an imprintable material comprises jetting the imprintable material into the microfluidic channel from a fluid jetting nozzle.

6. A method as in claim 1, wherein the imprint stamp comprises a topological channel pattern that mirrors a shape of the microfluidic channel, and wherein depositing an imprintable material comprises depositing the imprintable material within a full length of the microfluidic channel.

7. A method as in claim 1, wherein depositing an imprintable material comprises:
selectively depositing the imprintable material at a particular location in the microfluidic channel; and
controlling a channel length dimension of the imprintable material within the microfluidic channel.

8. A method as in claim 7, wherein controlling a channel length dimension of the imprintable material comprises jetting the imprintable material into the microfluidic channel within the channel length dimension.

9. A method as in claim 7, wherein controlling a channel length dimension of the imprintable material comprises:
photo curing imprintable material that has been deposited within the channel length dimension; and
washing away non-cured imprintable material that has been deposited outside of the channel length dimension.

10. A method of fabricating a microfluidic channel filter, comprising:
jetting a photo-curable liquid resist into a localized area of a microfluidic channel;
pressing an imprint stamp into the liquid resist;
applying an ultra-violet light to the liquid resist until the liquid resist is cured;
removing the imprint stamp from the cured liquid resist, leaving a filter pattern from the imprint stamp in the cured liquid resist.

11. A microfluidic channel filter comprising:
a substrate;
a microfluidic channel formed in the substrate;
an imprintable polymer material deposited in the microfluidic channel and imprinted with a filter pattern.

12. A filter as in claim 11, wherein the imprintable polymer material is localized within a precise channel length dimension.

13. A filter as in claim 11, wherein the imprintable polymer material comprises a photo-curable liquid resist that is jettable into the microfluidic channel from a fluid jet device.

14. A filter as in claim 11, wherein the filter pattern comprises a finger pattern with fingers selected from the group consisting of same-sized fingers and different-sized fingers.

15. A filter as in claim 11, wherein the substrate comprises a transparent substrate to enable an ultra-violet light cure of the imprintable polymer material.
